(19) United States
(12) Patent Application Publication
(10) Pub. No.: US 2020/0205947 A1
(43) Pub. Date: Jul. 2, 2020

(54) Positioning Method and System for Implant-Supported Dentures

(71) Applicant: Global Dental Science, LLC, Scottsdale, AZ (US)

(72) Inventors: Johannes Petrus Michael Grobbee, Oosterbeek (NL); Timothy Carroll Thompson, Fountain Hills, AZ (US); Stephen F. Balshi, Ft. Washington, PA (US); Glenn Wolfinger, Ft. Washington, PA (US)

(21) Appl. No.: 16/586,900

(22) Filed: Sep. 27, 2019

Related U.S. Application Data
(63) Continuation-in-part of application No. 15/181,032, filed on Jun. 13, 2016, now abandoned.
(60) Provisional application No. 62/174,391, filed on Jun. 11, 2015.

(51) Int. Cl. A61C 13/36; A61C 13/01; A61C 13/00; A61C 13/103; A61C 1/08

(52) U.S. Cl. CPC A61C 13/1016; A61C 13/04; A61C 1/084; A61C 13/0004; A61C 13/1009; A61C 13/0019

(57) ABSTRACT

An implant-supported denture placement and alignment system may include a denture apparatus. The denture apparatus may have a denture base and a denture base positioning system. The denture base may comprise an implant guide system and be connectable to implants. In this manner, the denture apparatus may be positioned so that it is mountable to the implants placed according to the implant guide following their placement in a patient's mouth.

### RELATED APPLICATIONS

This application claims priority from U.S. Provisional Application No. 62/546,404 filed on Aug. 16, 2016 and entitled “Implant Position Transfer Body and Universal, One-Piece, Scan Body to Register Implant Orientation Directly from a Dental Impression,” the entire contents of which are hereby fully incorporated herein. This application claims the priority and benefit of U.S. application Ser. No. 15/181,032 filed Jun. 13, 2016 titled “POSITIONING METHOD AND SYSTEM FOR IMPLANT-SUPPORTED DENTURES”, and of US Prov. Pat. No. 62/174,391 filed Jun. 411, 2015 titled “POSITIONING METHOD AND SYSTEM FOR IMPLANT-SUPPORTED DENTURES”.

### FIELD OF INVENTION

The present invention relates to implant-supported dentures. More particularly, the present invention relates to a positioning method and system integrated in the implant-supported denture to accurately place the implant-supported denture after the implants are placed.

### BACKGROUND OF THE INVENTION

In the field of dentures, one difficulty faced by dental surgeons is when a patient does not possess sufficient teeth in the jaw, but has enough bone in the jaw to support implants. A regular denture (e.g., not implant supported) rests on the gums, and is not supported by implants. However, regular dentures are prone to movement and unwanted shifting during use, among other challenges. In some instances, an implant-supported denture is used, which is a type of denture that is supported by and attached to the implants. An implant-supported denture has special attachments that affix onto attachments on the implants. However, implant-supported dentures present challenges arising from difficulties in properly aligning the denture to the implants.

Implant-supported dentures may be desired for the lower jaw because regular dentures tend to be unstable there. Moreover, implant-supported dentures may also be desired for an upper jaw. Thus, a patient may receive an implant-supported denture in either the upper or the lower jaw.

The implant-supported denture may be installed onto the implants creating a fixed detachable prosthesis. There are significant challenges in accurately siting the implant attachment points in the implant-supported denture, however. For instance, at the time of the implant placement in the patient's jaw, an implant-supported denture may be placed on the implants using temporary copings or temporary abutments. Later, a permanent implant-supported denture is manufactured, having a custom support bar that attaches to the implants and supports the permanent implant-supported denture. Thus, multiple appointments, and challenging and costly duplication processes are often needed to create the permanent implant-supported denture with custom support bar that corresponds in shape and maps to the alignment of the implant-supported denture to the implants. Thus, there is a need for a system and method for positioning implant supported dentures accurately after implants are placed, and without the time, expense, and potential errors of mapping implant sites to an implant-supported denture, then further mapping to a permanent implant-supported denture that corresponds to the implant-supported denture. Moreover, the custom support bar adds both time, and expense to the denture creation process.

### SUMMARY OF THE INVENTION

In accordance with various aspects of the present invention, a method and system for positioning implant-supported dentures is provided. A denture base positioning system may be integrated in the design of a temporary and/or permanent implant-supported denture. In accordance with an exemplary embodiment, labial and buccal pins are used to position the temporary and/or permanent implant-supported denture in a position corresponding to the desired relation to the implants placed by a implant guide channels within the denture base positioning system.

In accordance with various aspects of the present invention a denture base is configured to rest against a patient's at least partially edentulous ridge and having a mesiodistal axis co-planar with the patient's at least partially endentulous ridge, the denture base comprising a first side; a denture base member; the denture base member extending outwardly from the first side of the denture base, the denture base member forming a passageway extending in a labial or buccal and a lingual direction from the mesiodistal axis of the denture base and having a labial or buccal opening and a lingual opening configured for accessing the patient's at least partially edentulous ridge; the denture base member configured to mate with at least one of a labial pin and a buccal pin used in a denture base positioning system to position the denture base to the jaw; the denture base member further comprising a coronal portion and a apical portion, the passageway being open at the apical portion at the labial or buccal opening so that the passageway may snap onto the labial pin or buccal pin; and the denture base member of further comprising at least one implant placement guide and capable of functioning as a surgical apparatus comprising a surgical guide for placing implants; wherein the denture base positioning system comprises at least one of a labial pin used in the denture base positioning system to position the denture base to a jaw; and a buccal pin used in the denture base positioning system to position the denture base to the jaw; wherein at least one of the labial pin and the buccal pin comprise a screw; wherein at least one of the labial pin and the buccal pin comprise a mini-implant; wherein the denture base positioning system comprises a snap-on clip configured to connect the denture base positioning system to at least one of a labial pin and a buccal pin.

In accordance with various aspects of the present invention a method of positioning implant supported dentures may comprise positioning a denture arch proximate to a jaw, wherein the denture arch comprise an implant drilling guide configured to guide installation of an implant through channels in the guide an a positioning system; the method further comprising anchoring the denture arch to the jaw by the positioning system; installing an implant into the jaw; filling the channels in the guide, so that the denture arch is a fully functional artificial dentition prosthetic device.

In accordance with various aspects of the present invention a method of making a denture apparatus may comprise creating an electronic model of a denture arch having an implant guide comprising an implant guide positioning system comprising at least one labial pin and buccal pin; forming a denture apparatus comprising a denture apparatus positioning system by at least one of 3D printing, layer manufacturing, additive manufacturing, machining and milling, in response to the electronic model of the surgical guide; wherein the denture apparatus positioning system comprises at least one of a labial pin and a buccal pin corresponding to the at least one labial pin and buccal pin of the surgical guide positioning system.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a block diagram of an implant-supported denture placement and alignment system, in accordance with various embodiments;

FIG. 2 illustrates an edentulous lower jaw, in accordance with various embodiments;

FIG. 3 illustrates a lower jaw with a surgical guide, in accordance with various embodiments;

FIG. 4 illustrates a lower jaw with a surgical guide anchored with pins, in accordance with various embodiments;

FIG. 5 illustrates a lower jaw with implants placed through a surgical guide, in accordance with various embodiments;

FIG. 6 illustrates a lower jaw with temporary copings/abutments placed on the implants, in accordance with various embodiments;

FIG. 7A illustrates a lower jaw with an implant-supported denture with integrated positioning system, in accordance with various embodiments;

FIGS. 7B and 7C depict a implant-supported denture with integrated positioning system having a snap function, in accordance with various embodiments;

FIG. 8 illustrates a implant-supported denture with bonded temporary copings/abutment, in accordance with various embodiments;

FIG. 9 illustrates an implant-supported denture with the positioning system removed;

FIG. 10 illustrates a method of positioning implant-supported dentures; and

FIG. 11 illustrates a method of making a denture apparatus.

FIG. 12 illustrates a top-perspective view of a provisional denture arch with guide channels and the positioning members.

FIG. 13 illustrates a bottom-perspective view of a provisional denture arch with guide channels and the positioning members.

FIG. 14 illustrates a front perspective view of a provisional denture arch with guide sleeves and the positioning members.

FIG. 15 illustrates a side perspective view of a full upper and lower provisional denture with guide sleeves and the positioning members.

FIG. 16 illustrates a top view of the artificial dentition of a provisional denture arch with guide channels and the positioning members.

FIG. 17 illustrates a rear perspective view of a provisional denture arch with guide sleeves and the positioning members.

FIG. 18 illustrates a top view of the palatal portion of a provisional denture arch with guide channels and the positioning members.

FIG. 19 illustrates a bottom view of the gingival abutting ridge of a provisional denture arch with guide channels and the positioning members.

FIG. 20 illustrates a side perspective view of a provisional denture arch with guide sleeves and the positioning members.

### DETAILED DESCRIPTION

The present invention may be described herein in terms of various components. It should be appreciated that such components may be realized by any number of structural materials and components configured to perform the specified functions. For example, the present invention may be practiced in any number of dental contexts and the exemplary embodiments relating to a positioning system for implant supported dentures are merely a few of the exemplary applications for the invention. For example, the principles, features and methods discussed may be applied to any crown and bridge restorative dentistry, orthodontics or dental treatment application.

In accordance with various aspects of the present invention, an implant-supported denture placement and alignment system is provided to accurately position the temporary or final implant-supported denture.

Recent developments in fully milled monolithic dentures have led to the creation of stronger dentures. For instance, various related systems and methods for manufacturing layered dentures are provided in pages 3-24 of U.S. patent application Ser. No. 14/195,348, entitled “SYSTEM AND METHOD FOR MANUFACTURING LAYERED DENTURES” and filed on Mar. 3, 2014 and pages 3-18 of U.S. patent application Ser. No. 13/830,963, entitled “SYSTEM AND PROCESS FOR MANUFACTURING OF DENTURES” and filed on Mar. 14, 2013, and are incorporated by reference herein. For instance, various systems and methods of positioning implant support dentures as discussed herein may be applied to the layered dentures incorporated by reference.

Similarly, various systems and methods for molding thermosetting plastics, such as to form various features of the system disclosed herein are provided in pages 2-11 of U.S. patent application Ser. No. 13/369,238, entitled “PROCESS AND SYSTEMS FOR MOLDING THERMOSETTING PLASTICS” and filed on Feb. 8, 2012 and are incorporated by reference.

Moreover, various systems and methods for reference and registration of implant supported dentures such as for use in combination with various teachings herein are provided in pages 3-22 of U.S. patent application Ser. No. 14/013,295, entitled “DENTURE REFERENCE AND REGISTRATION SYSTEM” and filed on Aug. 29, 2013 and are incorporated by reference, as are various systems and methods for reference and registration of implant supported dentures such as for use in combination with various teachings herein which are provided in pages 3-22 of U.S. patent application Ser. No. 14/698,649, entitled “DENTURE REFERENCE AND REGISTRATION SYSTEM” and filed on Apr. 28, 2015, and which are also incorporated by reference.

Thus, in accordance with various aspects of the present invention, a permanent implant-supported denture denture may also comprise an implant-supported denture, such that a single denture may serve as both the temporary post-operative denture, and the patient's permanent denture. For instance, such a denture may in various embodiments omit a custom support bar and yet, exhibit sufficient strength and durability to serve as a final detachable permanent implant-supported denture.

In accordance with various aspects of the present invention, a method of positioning implant-supported dentures is provided. In various embodiments, implants may be placed in a patient's jaw. The implant installation sites may be established by use of a surgical guide. For instance, a surgical guide may guide a drill to bore holes in the bone of the patient's jaw and may also guide positioning of the implants. The surgical guide may be positioned in a patient's mouth and anchored prior to drilling. The surgical guide may be positioned and anchored by at least one of buccal and labial pins anchoring the surgical guide in the jaw.

The surgical guide may be scanned to collect a digital model of the surgical guide, or the electronic data used to create the surgical guide may be used to collect a digital model of the surgical guide. Based on the digital model, the positioning of the at least one buccal and labial pin may be copied to a digital model of an implant-supported denture, such as to create corresponding apertures in the model of the implant-supported denture. The implant-supported denture may be manufactured, and the corresponding apertures may permit the surgeon to easily position the implant-supported denture using the same buccal and/or labial pin positioning as in the surgical guide. In this manner, the implant-supported denture may be positioned precisely and accurately corresponding to the location digitally modeled and corresponding to the surgical guide.

The surgeon may anchor the implant-supported denture using the labial and/or buccal pins. Upon anchoring, temporary copings and/or abutments on the implants may be bonded to the implant-supported denture. Because the temporary denture has apertures corresponding to the buccal and/or labial pins of the surgical guide, the implant-supported denture has been positioned precisely and accurately according to the intended position electronically modeled to facilitate the proper relationship of the implant-supported denture to the implants. In this manner, when the temporary copings and/or abutments are bonded to the implant-supported denture, they are bonded at the desired sites to allow the implant-supported denture to be installed and exhibit proper balanced occlusion.

The implant-supported denture can now be removed, such as by the removal of buccal and/or labial pins, and released from the jaw. In various embodiments, the apertures corresponding to the buccal and/or labial pins of the surgical guide are oriented in a portion of the implant-supported denture that can be broken off prior to use by the patient. For instance, the positioning system may be removable in accordance with the systems and methods for dentures and for surgical guides disclosed in pages 2-12 of PCT Application No. PCT/US2014/017136, entitled “REMOVABLE SYSTEM AND METHOD FOR DENTURES AND SURGICAL GUIDES” and filed on Feb. 19, 2014, which are incorporated by reference as well as the systems and methods for dentures and for surgical guides disclosed in pages 2-12 of U.S. Provisional Patent Application No. 61/766,660, entitled “REMOVABLE SYSTEM AND METHOD FOR DENTURES AND SURGICAL GUIDES” and filed on Feb. 19, 2013, which are also incorporated by reference.

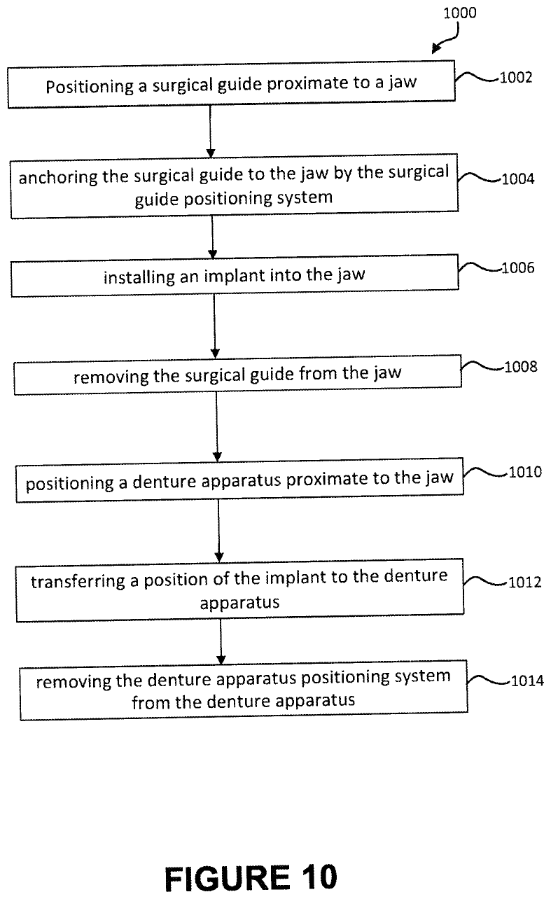

Accordingly, with reference to FIG. 10, a method 1000 of positioning implant supported dentures may comprise positioning a surgical guide proximate to a jaw (Step 1002) wherein the surgical guide comprises an implant drilling guide configured to guide installation of an implant and a surgical guide positioning system. The method may include anchoring the surgical guide to the jaw by the surgical guide positioning system (Step 1004), installing an implant into the jaw (Step 1006), and removing the surgical guide from the jaw (Step 1008). The method may further include positioning a denture apparatus proximate to the jaw (Step 1010), wherein the denture apparatus comprises a denture apparatus positioning system corresponding to the surgical guide positioning system, transferring a position of the implant to the denture apparatus (Step 1012), and removing the denture apparatus positioning system from the denture apparatus (Step 1014).

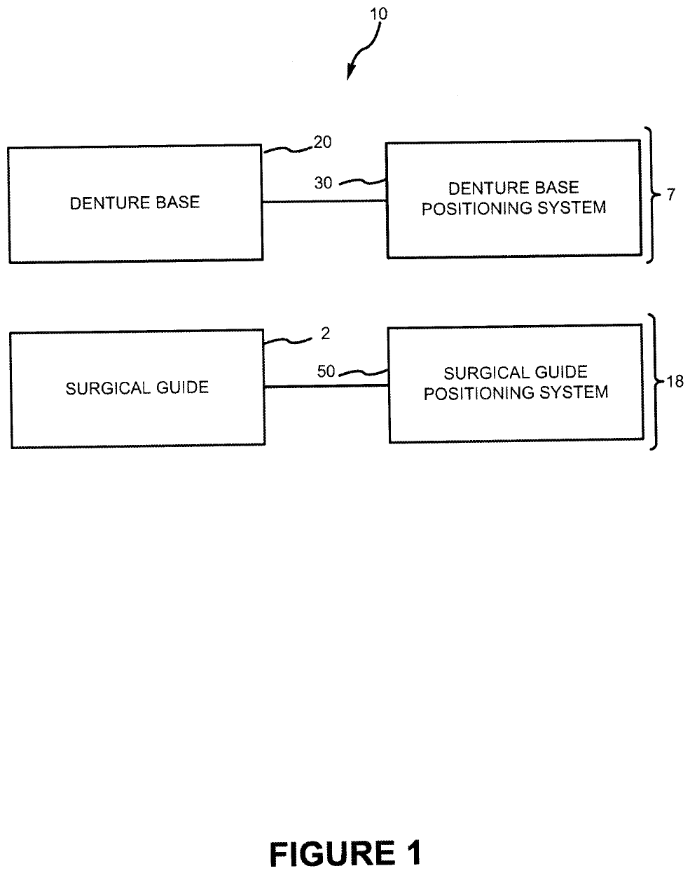

Having disclosed an exemplary method of positioning a temporary and/or permanent implant-supported denture, with reference now to various Figures, the positioning system for implant-supported dentures is discussed in greater detail below. For example, with reference to FIG. 1, an implant-supported denture placement and alignment system 10 may comprise a denture apparatus 7 comprising a denture base 20 and a denture base positioning system 30. The implant-supported denture placement and alignment system 10 may also comprise a surgical apparatus 18 comprising a surgical guide 2 and a surgical guide positioning system 50.

An implant-supported denture placement and alignment system 10 may be used to both site implants being installed in a patient's jaw, and to then transfer the implant sites to an implant-supported denture to be installed on the implants and to be worn by the patient. However, as discussed above, fully milled dentures may omit the use of a custom support bar to connect the implant-supported denture to the implants. As also discussed, it is desirable to match the implant sites both accurately and precisely to the denture base and account for any variations that may have arisen between the models used to create the surgical apparatus 18, and the actual patient outcome that includes the actual positioning of implants in the patient's jaw. Similarly, it is desirable that the denture base be installed immediately after surgery but also be usable as the permanent denture base 20 for long-term patient usage.

A surgical apparatus 18 may comprise a surgical guide 2 and a surgical guide positioning system 50. The surgical guide 2 may attach to a patient's jaw 1 and may provide guidance to the surgeon when drilling the jaw to accommodate implants. For instance, the surgical guide 2 may rest against a patient's edentulous ridges and/or jawbone and provide guidance to a drilling rod entering the jawbone. Surgical guide positioning system 50 may comprise an apparatus whereby the surgical guide 2 may be positioned relative to the jaw 1 and retained in fixed position relative to the jaw 1 while the surgeon is drilling the implant sites.

A denture apparatus 7 may be at least a portion of a denture prosthesis installed for patient wear such as a part of a temporary implant-supported denture or a permanent implant-supported denture. The denture apparatus 7 may comprise a denture base 20. The denture base 20 may provide support to artificial teeth making up a patient's denture. The denture base 20 may be positioned relative to a patient's edentulous ridges by a denture base positioning system 30. The denture base positioning system 30 may comprise a positioning aid that corresponds to the surgical guide positioning system 50. In this manner, the denture apparatus 7 may be aligned to correspond to the surgical apparatus 18, such as so that the implant sites may be transferred to the denture apparatus 7. For instance, the denture base positioning system 30 and the surgical guide positioning system 50 may comprise similar features so that each are aligned similarly to a patient's jaw 1. In various embodiments, the denture base positioning system 30 comprises similar features to the surgical guide positioning system 50, except that the denture base positioning system 30 comprises enlarged features, such as enlarged apertures, thereby permitting compensation of slight variations in the intended placement and actual placement of implant sites. In various embodiments, because variations between the intended placement and the actual placement of implants may arise, variations may be compensated by various mechanisms, such as wherein the implant sites may be transferred from the actual implants installed with aid of the surgical apparatus 18 to the denture apparatus 7, rather than the intended placement being transferred directly from the surgical apparatus 18 itself to the denture apparatus 7. In various embodiments, the denture base positioning system 30 also comprises enlarged features, such as enlarged apertures (relative to the surgical guide positioning system 50), further facilitating this compensation. In this manner, a denture apparatus 7 may be positioned both accurately and precisely relative to a patient's implants.

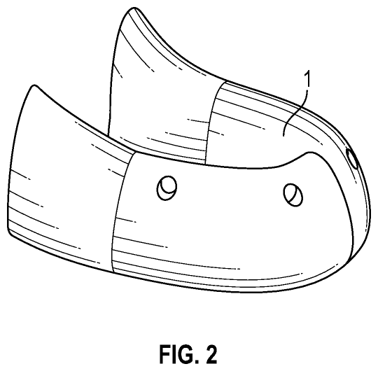

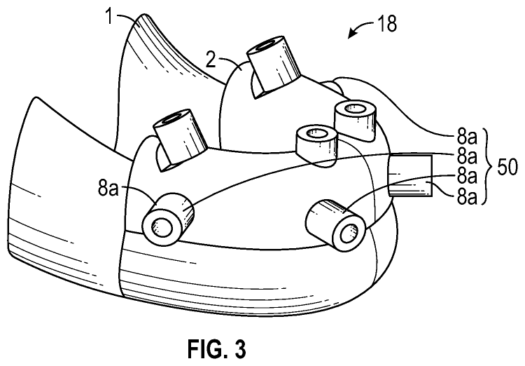

For example, with reference FIG. 2, a jaw 1, such as an edentulous lower jaw is illustrated. In FIG. 3, a surgical apparatus 18 comprising a surgical guide 2 and a surgical guide positioning system 50 is placed on the jaw 1, such as an edentulous lower jaw. As depicted, the surgical guide positioning system 50 comprises positioning members 8a.

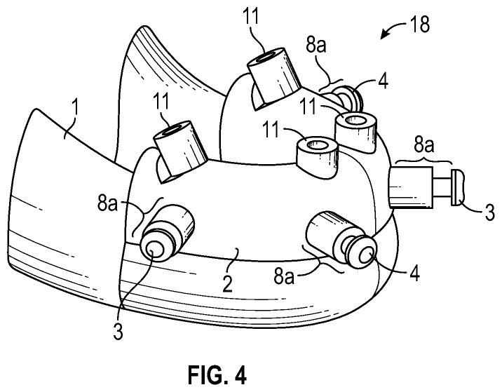

Various configurations and designs of surgical apparatus 18 are possible. For instance, various positioning members 8a may have various configurations. For instance, with reference to FIGS. 3-4, certain positioning members 8a may comprise buccal pins 3 and certain positioning members 8a may comprise labial pins 4. In various embodiments, the surgical guide positioning system 50 may comprise two positioning members 8a with buccal pins 3, and two positioning members 8a with labial pins 4. In further embodiments one buccal pin 3, or three buccal pins 3, or four buccal pins 3 or any number of buccal pins 3 may be implemented. Similarly, various embodiments may include one labial pin 4, three labial pins 4, four labial pins 4, or any number of labial pins 4 as desired.

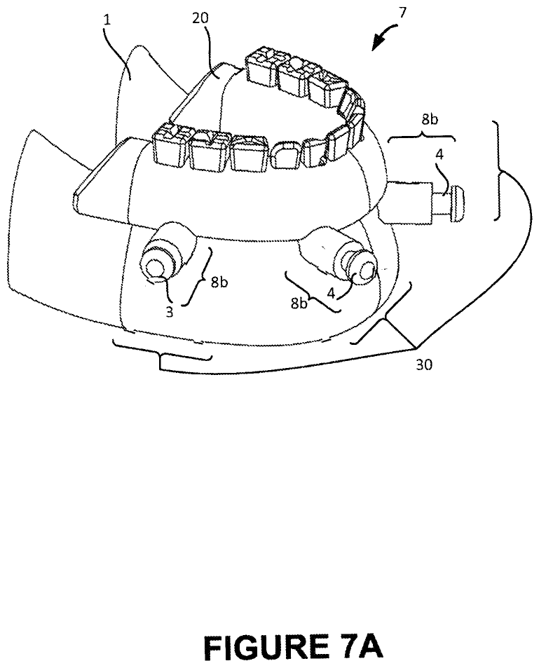

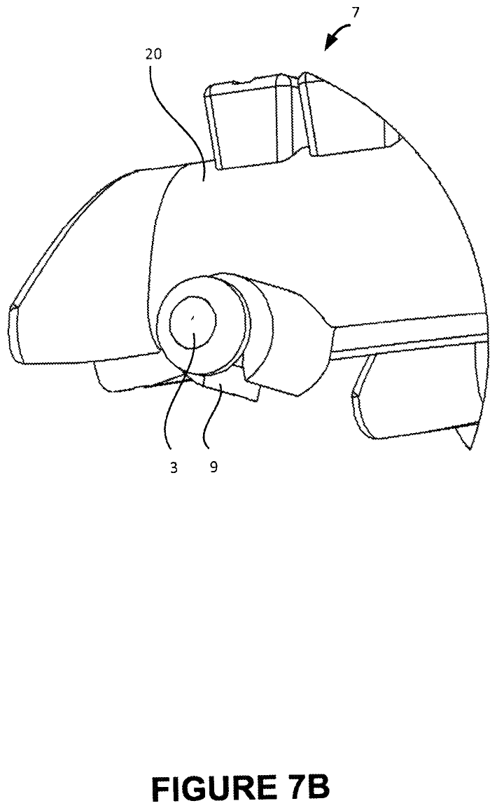

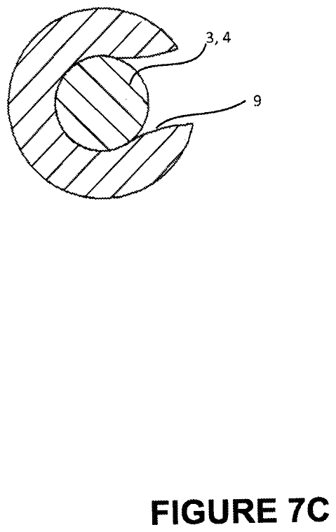

A buccal pin 3 may comprise a pin, screw, shaft, mini-implant, or other member connectable to an aperture defined by a positioning member 8a (or positioning member 8b according to FIG. 7A) and configured to contact a patient's gum and/or jaw 1. A buccal pin 3 may be positioned to contact a buccal region of the patient's gum and or jaw 1.

Similarly, a labial pin 4 may comprise a pin, screw, shaft, mini-implant or other member connectable to an aperture defined by a positioning member 8a (or positioning member 8b according to FIG. 7A) and configured to contact a patient's gum and/or jaw. A labial pin 4 may be positioned to contact a labial region of the patient's gum and/or jaw 1.

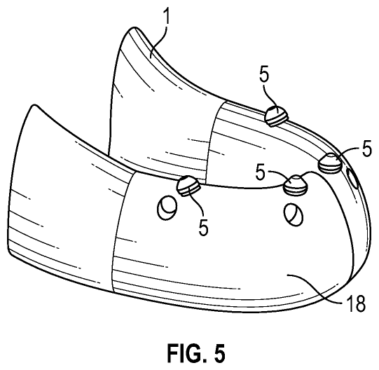

A surgeon may use the surgical apparatus 18 to assist in positioning implants 5 in a jaw 1 such as an edentulous jaw. For instance, with reference to FIG. 4, a surgical apparatus 18 may further comprise implant drilling guides 11. Implant drilling guides 11 may comprise channels disposed through the surgical apparatus 18 to guide a drilling rod on a path into a patient's jaw 1. An implant drilling guide 11 may comprise any structure configured to aid the surgeon in positioning implants 5 (FIG. 5) in a patient's jaw 1. With reference to FIG. 5, implants 5 are depicted having been placed in a jaw 1 with aid of the surgical apparatus 18 (FIG. 4).

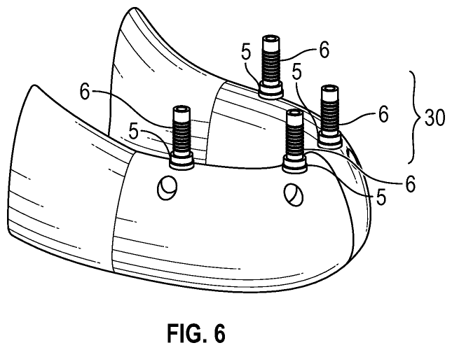

With reference to FIGS. 6 and 7A-C, subsequent to placement of the implants 5, there may be a desire to transfer the location of the implants 5 to prosthesis, such as a denture apparatus 7. For instance, the location of the implants 5 may be transferred to the underside (e.g., apical side) of a denture base 20. Moreover, due to tolerances in the surgical apparatus 18 (FIG. 4), such as to permit the free passage of a drilling rod, or due to variations in the patient's bone structure, and/or due to slight misalignments during the implant installation, there may be a need to accurately transfer the installed implant 5 locations to a denture apparatus 7, rather than simply mimic the surgical apparatus 18 (FIG. 4). Thus, while these locations may generally be identifiable with reference to electronic model data, such as may be used to construct the surgical apparatus 18 (FIG. 4), practical variations make it desirable to obtain precise and accurate placement data from the actual installed implants 5. As such, with reference to FIG. 6, the denture base positioning system 30 may comprise temporary copings/abutments 6. Temporary copings/abutments 6 may comprise fasteners attachable to implants 5, that may be placed on implants 5 and then transferred to a denture apparatus 7 (FIG. 7A) by seating of the denture apparatus 7 (FIG. 7A) on the jaw 1 proximate to the implants 5. For instance, the denture base 20 of the denture apparatus 7 may be placed over a patient's edentulous or partially edentulous ridge.

Now, referencing FIG. 7A, a denture base positioning system 30 of a denture apparatus 7 may further comprise positioning members 8b. The positioning members 8b of the denture apparatus 7 may be similar to the positioning members 8a of the surgical apparatus 18 (FIG. 4) discussed herein. Various configurations and designs of denture apparatus 7 are possible. For instance, various positioning members 8b may have various configurations. For instance, certain positioning members 8b may comprise buccal pins 3 and certain positioning members 8b may comprise labial pins 4. In various embodiments, the denture base positioning system 30 may comprise two positioning members 8b with buccal pins 3, and two positioning members 8b with labial pins 4. In further embodiments, one buccal pin 3, or three buccal pins 3, or four buccal pins 3 or any number of buccal pins 3 may be implemented. Similarly, various embodiments may include one labial pin 4, three labial pins 4, four labial pins 4, or any number of labial pins 4 as desired.

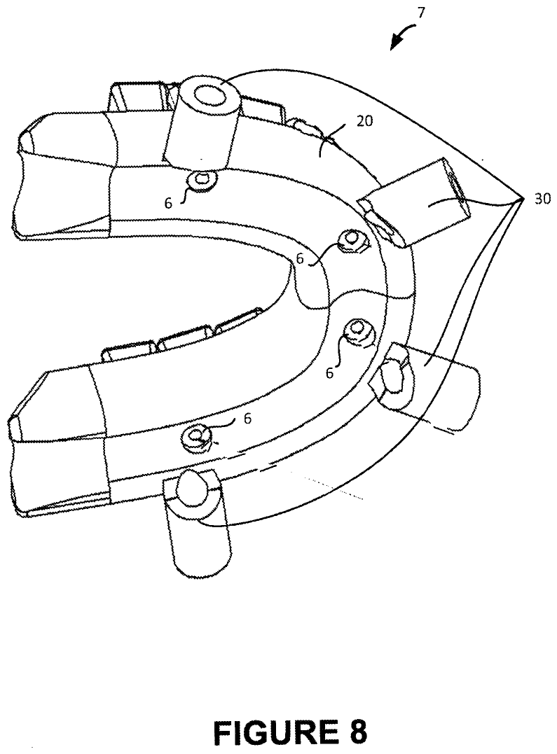

With reference to FIGS. 4 and 7A-C, the denture base positioning system 30 may comprise positioning members 8b corresponding in location to the positioning members 8a of the surgical guide positioning system 50, and may be positioned on the jaw 1 using the same and/or similar buccal pins 3 and/or labial pins 4 passing through corresponding apertures, or with different buccal pins 3 and/or labial pins 4 oriented to correspond to such apertures. Alternatively, with reference to FIG. 7B-C, a positioning member 8b may comprise a snap-on clip 9. A snap-on clip 9 may selectably join the denture apparatus 7 to a buccal pin 3 or labial pins 4. With reference to FIGS. 4 and 7A-C, in this manner, the denture base positioning system 30 may orient the denture apparatus 7 in a corresponding location relative to the jaw 1, as was the surgical apparatus 18. Subsequently, physical contact may occur between the temporary copings/abutments 6 (FIGS. 6 and 8) and the underside of the denture base 20 of the denture apparatus 7, and the copings/abutments 6 (FIGS. 6 and 8) may bond to the denture base 20 of the denture apparatus 7, such as by adhesive. With reference to FIG. 8, the temporary copings/abutments 6 may be bonded to the denture base 20 of the denture apparatus 7. The buccal pins 3 and/or labial pins 4 may be released and the denture apparatus 7, with the bonded copings/abutments 6 thus released from the jaw 1.

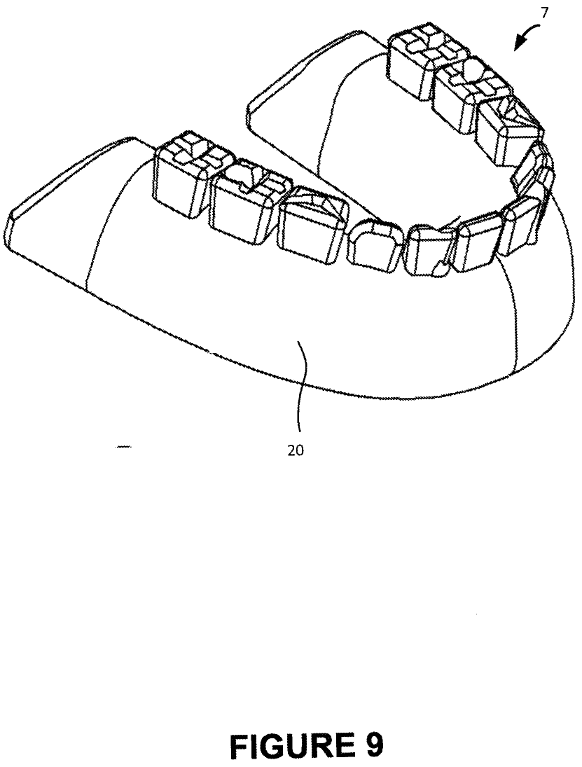

The denture base positioning system 30 may be removed from the denture apparatus 7 in preparation for use by the patient of the denture apparatus 7. With reference to FIGS. 8 and 9, the denture base positioning system 30 may be removed from the denture apparatus 7. For instance, the denture base positioning system 30 may be ground off the denture apparatus 7 to form a temporary and/or permanent denture. Moreover, the denture base positioning system 30 may be removable, for instance, the denture base positioning system 30 may be snapped off, such as in accordance with the systems and methods for dentures and for surgical guides disclosed in pages 2-12 of PCT Application No. PCT/US2014/017136, entitled “REMOVABLE SYSTEM AND METHOD FOR DENTURES AND SURGICAL GUIDES” and filed on Feb. 19, 2014, which are incorporated by reference as well as the systems and methods for dentures and for surgical guides disclosed in pages 2-12 of U.S. Provisional Patent Application No. 61/766,660, entitled “REMOVABLE SYSTEM AND METHOD FOR DENTURES AND SURGICAL GUIDES” and filed on Feb. 19, 2013, which are also incorporated by reference. Consequently, with reference to FIG. 9, a finished denture apparatus 7 may be presented to the patient for installation and use with all or part of denture base positioning system 30 removed from denture apparatus 7, forming a temporary and/or permanent denture including a denture base 20.

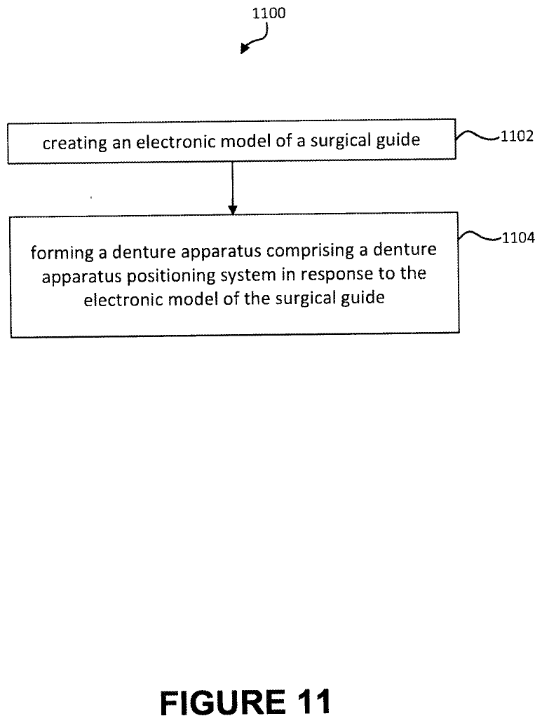

Having discussed an exemplary method of positioning implant supported dentures and having discussed various aspects of a positioning system for implant supported dentures and related components, a method of making a denture apparatus is disclosed. For instance, with reference to FIG. 11, a method 1100 of making a denture apparatus may involve creating an electronic model of a surgical guide comprising a surgical guide positioning system comprising at least one labial pin and buccal pin (Step 1102). The method may include forming a denture apparatus comprising a denture apparatus positioning system by at least one of 3D printing, layer manufacturing, additive manufacturing, machining, and milling, in response to the electronic model of the surgical guide (Step 1104). The denture apparatus positioning system may include at least one of a labial pin and a buccal pin corresponding to the at least one labial pin and buccal pin of the surgical guide positioning system.

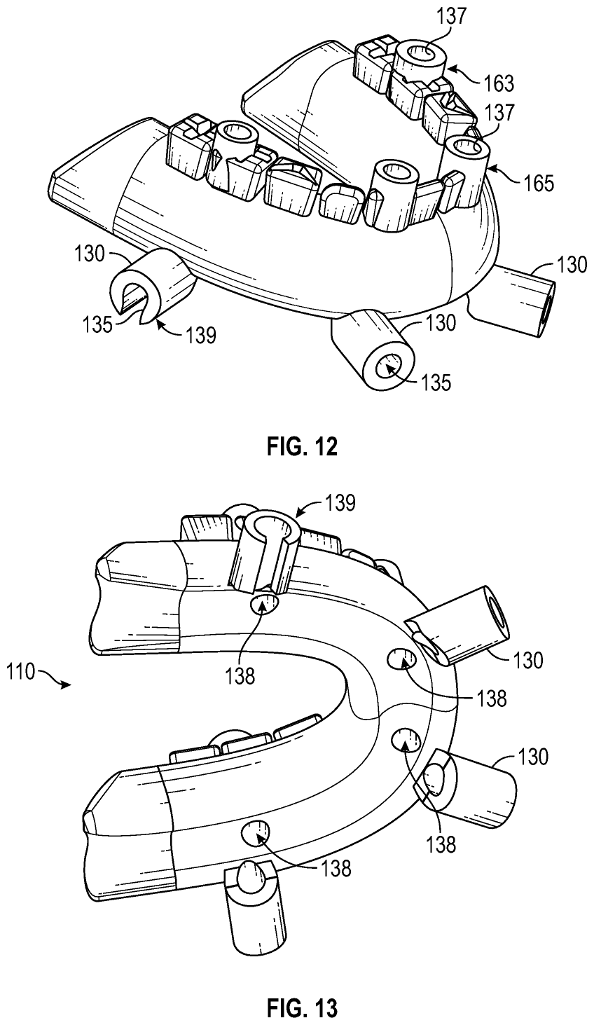

Looking now to FIGS. 12 and 13, an embodiment of the inventive denture arch is illustrated with the implant guide channels extending upwardly from the artificial dentition. The implant guide channels may extend up to and past the altitude of the artificial teeth. As shown, channels have a cylindrical shape with a first opening at the tooth side of the denture arch in FIG. 12 and a second opening at the palate side of the denture arch in FIG. 13. Positioning members may have a first side and a second side, and may be utilized as partial members with snap-on clips, as at least partially enclosed members, or as fully enclosed members. In this embodiment, positioning members may resemble any of the embodiments disclosed elsewhere in this application.

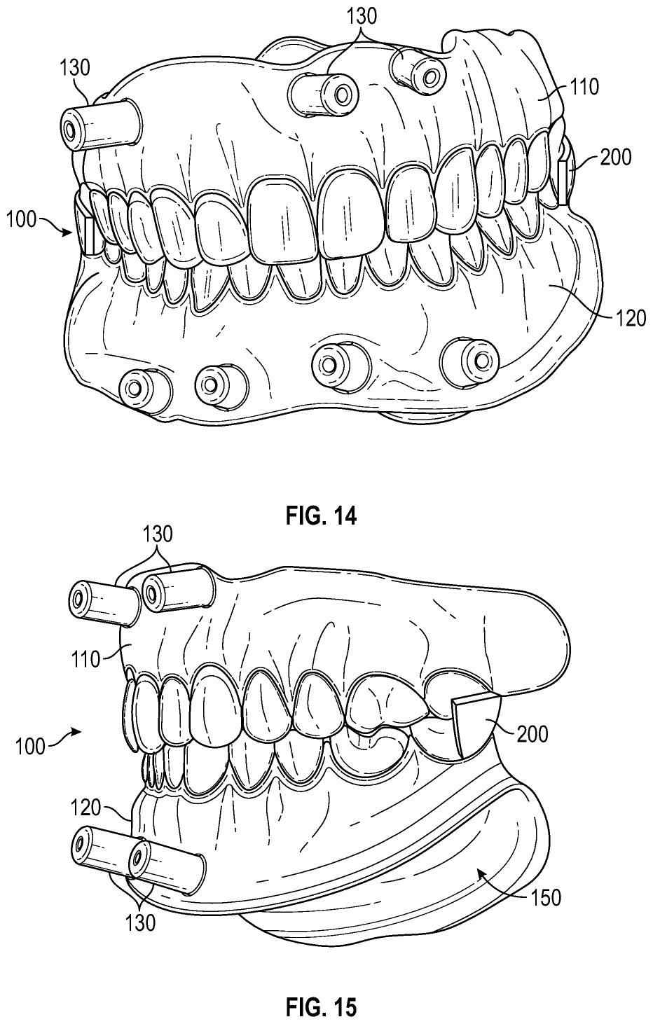

FIGS. 14-20 disclose embodiments of an upper and lower denture arch having denture positioning members having a passageway through which a pin, implant or other positioning tool known in the arts may be guided therethrough to the patient's gingiva and into the jaw. Denture positioning member 130 may form a passageway 135 extending in a labial or buccal and a lingual direction from the mesiodistal axis of the denture base and having a labial or buccal opening and a lingual opening configured for accessing the patient's at least partially edentulous ridge. Access sites 160 may include aiding structures 165 that emanate from the access site 160 to aid in the practitioner's drilling and placement of the implants into the patient jawbone, and FIG. 13 shows an opening 162 on the intaglio side of the lower arch 120. As shown, channels for access sites 160 may have a cylindrical shape with a first opening 137 at the tooth side of the denture arch in FIG. 12 and a second opening 138 at the palate side of the denture arch in FIG. 13. Positioning members 130 may have a first side 132 and a second side 133, and may be utilized as partial members with snap-on clips 139, as at least partially enclosed members, or as fully enclosed members. In this embodiment, positioning members 130 may resemble any of the embodiments disclosed elsewhere in this application.

In an embodiment of the invention, methods for installing denture arches using implant guide channels and positioning members may be followed, as seen in FIG. 1 with step 7 and with the denture base having guide holes in FIGS. 7a, 8 and 9 along with FIGS. 14-20, without using a separate surgical guide.

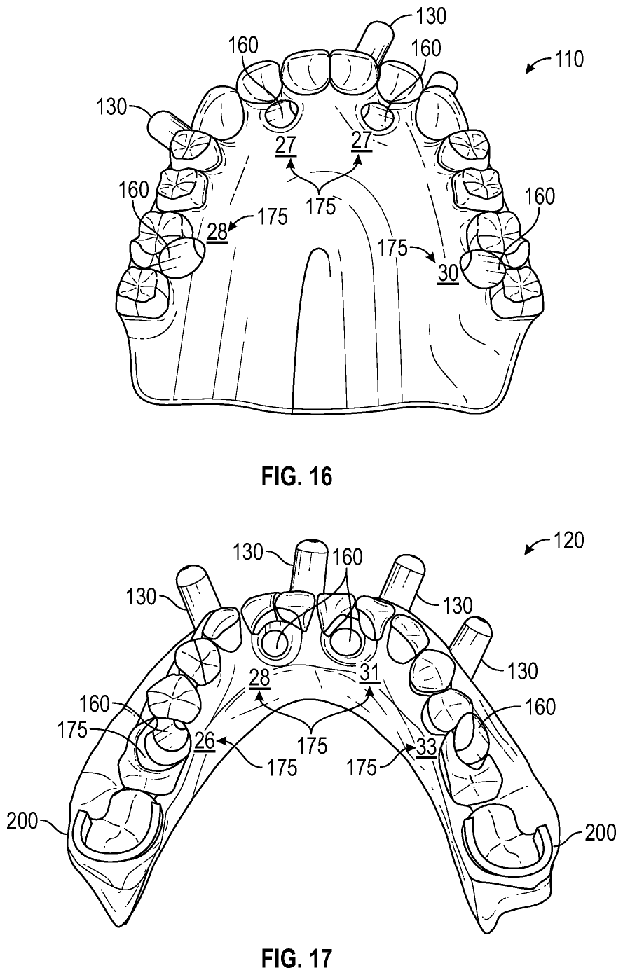

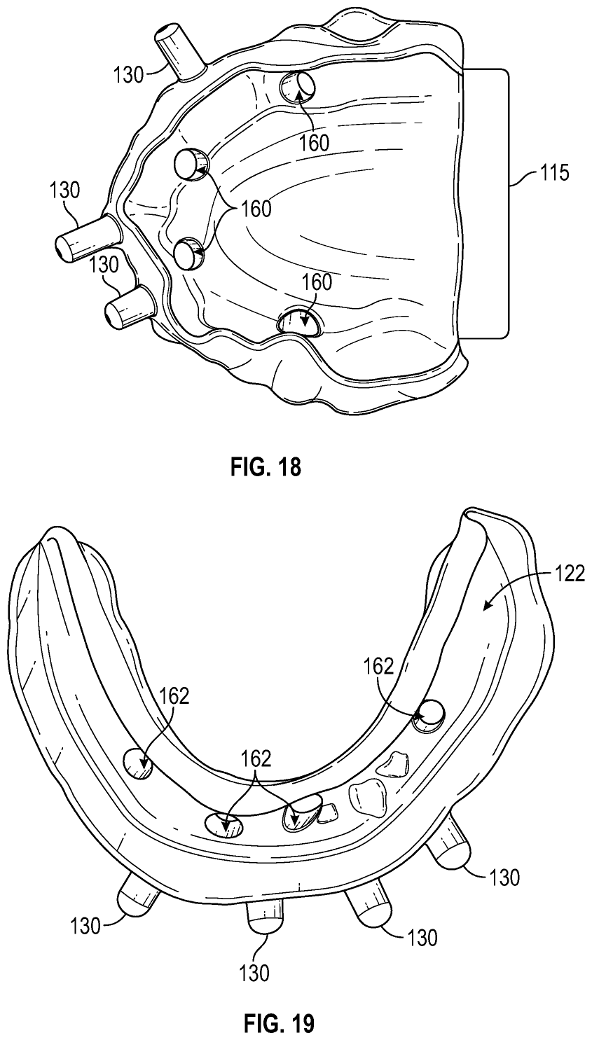

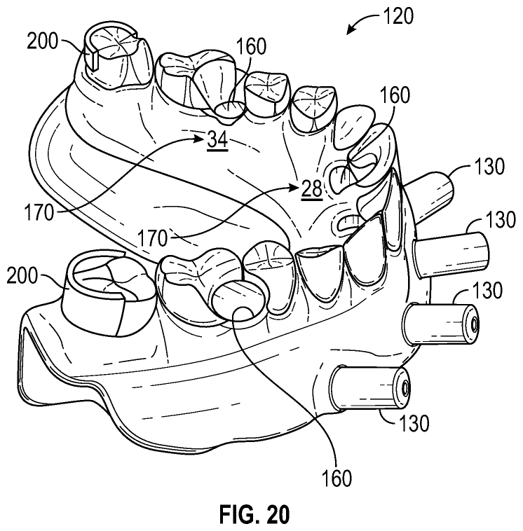

Looking at FIG. 14, a dual arch full denture 100 is disclosed having an upper arch 110 and a lower arch 120. In an embodiment of the invention, the upper arch 110 may comprising at least one positioning member 130. As depicted in the FIG. 14, positioning member 130 includes three (3) positioning members though more are within the scope of the invention. The lower arch 120 may comprise at least one positioning member 130 in an embodiment of the invention, and includes four (4) positioning members as illustrated. The full denture is presented as being occluded as designed and manufactured. In an embodiment, occlusal locks 200 may be included towards the anterior of the arch to mate the upper and lower arches. FIG. 15 shows a lateral or side view of the same arch in FIG. 14, highlighting the occlusal lock 200 and showing the arch interface 150 to the lower jaw at the base of lower arch 120. FIG. 16 shows an occlusal perspective view of an upper arch 110 in an embodiment of the invention. As depicted, access sites 160 may serve as a surgical guide for instrumentation that a practitioner may utilize for drilling into the patient jawbone for implant placement, as described in the present application. Nearby the pre-drilled sites 160, drill depth values 170 may be printed on the arch 110. In an embodiment of the invention, the access sites 160 may have aiding structures in the drilling instrumentation utilized for drilling into the patient jawbone. As illustrated, the aiding structure includes a beveled ridge 175. FIG. 17 illustrates an embodiment of the invention addressing the lower arch 120, depicted the occlusal lock 200 that mates with an upper arch 110, the access sites 160, positioning members 130, and drill depth values 170. FIG. 18 illustrates the intaglio view of the upper arch 110, or the portion 115 that interfaces with the patient's upper jaw and palate. In an embodiment of the invention shown, the upper arch 110 may have access sites opening 162 and positioning members 130 as described above. FIG. 19 illustrates an intaglio view of the lower arch 120, showing the access sites openings 162 as they relate to the intaglio surface 125 of the lower arch that interfaces with the lower jaw of a patient. FIG. 20 illustrates the lower arch 120 from a lateral view, indicating the occlusal locks 200, drill depth values 175, and access sites 160.

In practice, the practitioner may position a denture arch proximate to a jaw, the denture arch may comprise an implant drilling guide configured to guide installation of an implant through channels in the guide, a positioning system. The user may anchor the denture arch to the jaw by the positioning system and install an implant into the jaw. The user may fill the channels in the implant guide using materials known in the arts such as flowable or injectable prosthetic materials, or a pre-milled or manufactured (by additive or reductive) portion fixed into the channel by glue or other affixing means.

In another embodiment of the invention, a method of making a denture apparatus may comprise creating an electronic model of a denture arch having an implant guide comprising an implant guide positioning system comprising at least one labial pin and buccal pin; forming a denture apparatus comprising a denture apparatus positioning system by at least one of 3D printing, layer manufacturing, additive manufacturing, machining and milling, in response to the electronic model of the surgical guide. The denture apparatus positioning system may comprise at least one of a labial pin and a buccal pin corresponding to the at least one labial pin and buccal pin of the surgical guide positioning system.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims.

1. A denture base configured to rest against a patient's at least partially edentulous ridge and having a mesiodistal axis co-planar with the patient's at least partially endentulous ridge, the denture base comprising
a first side;
a denture base member; the denture base member extending outwardly from the first side of the denture base, the denture base member forming a passageway extending in a labial or buccal and a lingual direction from the mesiodistal axis of the denture base and having a labial or buccal opening and a lingual opening configured for accessing the patient's at least partially edentulous ridge;
the denture base member configured to mate with at least one of:
a labial pin and a buccal pin used in a denture base positioning system to position the denture base to the jaw;
the denture base member further comprising a coronal portion and a apical portion, the passageway being open at the apical portion at the labial or buccal opening so that the passageway may snap onto the labial pin or buccal pin; and
the denture base member of further comprising at least one implant placement guide and capable of functioning as a surgical apparatus comprising a surgical guide for placing implants.

2. A denture apparatus of claim 1, wherein the denture base positioning system comprises at least one of:
a labial pin used in the denture base positioning system to position the denture base to a jaw; and
a buccal pin used in the denture base positioning system to position the denture base to the jaw.

3. A denture apparatus of claim 2, wherein at least one of the labial pin and the buccal pin comprise a screw.

4. A denture apparatus of claim 2, wherein at least one of the labial pin and the buccal pin comprise a mini-implant.

5. A denture apparatus of claim 1, wherein the denture base positioning system comprises a snap-on clip configured to connect the denture base positioning system to at least one of a labial pin and a buccal pin.

6. A method of positioning implant supported dentures comprising:
positioning a denture arch proximate to a jaw, wherein the denture arch comprises:
an implant drilling guide configured to guide installation of an implant through channels in the guide; and
a positioning system;
anchoring the denture arch to the jaw by the positioning system;
installing an implant into the jaw;
filling the channels in the guide, so that the denture arch is a fully functional artificial dentition prosthetic device.

7. A method of making a denture apparatus comprising:
creating an electronic model of a denture arch having an implant guide comprising an implant guide positioning system comprising at least one labial pin and buccal pin; and
forming a denture apparatus comprising a denture apparatus positioning system by at least one of 3D printing, layer manufacturing, additive manufacturing, machining and milling, in response to the electronic model of the surgical guide.

8. The method of claim 7, wherein the denture apparatus positioning system comprises at least one of a labial pin and a buccal pin corresponding to the at least one labial pin and buccal pin of the surgical guide positioning system.
